(19) United States
(12) Patent Application Publication
(10) Pub. No.: US 2019/0078946 A1
(43) Pub. Date: Mar. 14, 2019

(54) SUPERCAPACITOR-BASED SENSORS WITH FLEXIBLE ELECTROLYTES

(71) Applicant: Regents of the University of Minnesota, Minneapolis, MN (US)

(72) Inventors: Ye Zhang, Minneapolis, MN (US); Rajesh Rajamani, Saint Paul, MN (US); Serdar A. Sezen, Minneaplis, MN (US)

(21) Appl. No.: 16/127,827

(22) Filed: Sep. 11, 2018

Related U.S. Application Data
(60) Provisional application No. 62/556,837, filed on Sep. 11, 2017.

(51) Int. Cl. G01L 1/14; H01G 11/26; H01G 11/56; H01G 11/84; G01L 5/16

(52) U.S. Cl. CPC G01L 1/142; H01G 11/26; G01L 5/165; H01G 11/84; H01G 11/56

(57) ABSTRACT

Supercapacitor-based sensors having flexible solid-state electrolytic elements are described. The deformation of the electrolytic element in response to an applied force or strain changes the area of capacitive layers defined by contacting surfaces of the electrolytic element and one or more electrodes of the sensor. The resulting change in capacitance of the capacitive double layers is indicative of the magnitude of the applied force or of the strain. The flexible solid-state electrolytic element may include cellulosic material distributed in a cured ionic polymeric matrix. Techniques for forming the flexible solid-state electrolytic element include wetting a cellulosic material with a photocurable composition comprising an ionic liquid, a prepolymer composition, and a photoinitiator, and photocuring the photocurable composition for a predetermined curing period by exposing the wetted cellulosic material to a predetermined curing wavelength.

This application claims the benefit of U.S. Provisional Application No. 62/556,837 filed Sep. 11, 2017, which is incorporated herein by reference in its entirety.

### TECHNICAL FIELD

This disclosure relates to sensors and, more specifically, supercapacitor-based force and strain sensors.

### BACKGROUND

Sensors and sensing platforms are widely used in many applications, including industrial, medical, commercial, and consumer applications. For example, force and tactile sensors are widely used to measure the presence or magnitude of an applied contact, force, or pressure. A force sensor typically includes a transducer that converts a mechanical or physical input to an electronic signal indicative of the presence or magnitude of an applied force. A capacitive force sensor is one particular example of a force sensor and is configured to exhibit a change in capacitance in response to an applied force. Typically, a distance between electrodes of the capacitor changes due to applied force. Thus, the capacitance may be periodically or continuously monitored, for example, by a controller, to receive electronic signals indicative of a change in capacitance, and ultimately, of a change in applied force.

### SUMMARY

The disclosure describes supercapacitor-based sensors that include flexible solid-state electrolytic elements, and techniques for forming flexible solid-state electrolytic elements. The deformation of a flexible electrolyte in response to an applied force changes the area of contact of the electrolyte with electrodes of a supercapacitor. The resulting change in capacitance is indicative of the magnitude of the applied force and may be used to output an electronic signal indicative of the sensed force.

In some examples, the disclosure describes an example article including a positive electrode and a negative electrode spaced apart from the positive electrode. The example article includes a flexible solid-state electrolytic element adjacent to and positioned between the positive and negative electrodes and in contact with the positive and negative electrodes. The flexible solid-state electrolytic element is configured to deform and exhibit a change in respective areas of contact with one or both of the positive or negative electrodes in response to a force or strain applied on the flexible solid-state electrolytic element. The areas of contact between the flexible solid-state electrolytic element and the positive and negative electrodes respectively define a first and second capacitive double layer.

In some examples, the disclosure describes an example technique for forming a flexible solid-state electrolytic element. The example technique includes wetting a cellulosic material with a photocurable composition comprising an ionic liquid, a prepolymer composition, and a photoinitiator. The example technique includes photocuring the photocurable composition for a predetermined curing period by exposing the wetted cellulosic material to a predetermined curing wavelength of light.

### BRIEF DESCRIPTION OF THE DRAWINGS

FIG. 1 is a schematic representation of a supercapacitor including electrodes in contact with an electrolytic solution.

FIG. 2A is a photograph illustrating an example droplet-based capacitive sensor.

FIG. 2B is a schematic side view of the droplet-based sensor of FIG. 2A at an initial state without load.

FIG. 2C is a schematic side view of the sensor of FIG. 2B at a loaded state.

FIG. 3A is a conceptual and schematic exploded plan view of an example article including a flexible solid-state electrolytic element.

FIG. 3B is a conceptual and schematic top view of the example article sensor of FIG. 3A.

FIG. 3C is a conceptual and schematic cross-sectional view of the example article of FIG. 3A.

FIG. 4 is a conceptual and schematic cross-sectional view of an example article including a cylindrical flexible solid-state electrolytic element.

FIG. 5 is a conceptual and schematic cross-sectional view of an example article including a corrugated flexible solid-state electrolytic element.

FIG. 6 is a conceptual and schematic cross-sectional view of an example article including a flexible solid-state electrolytic element layer applied to a substrate.

FIG. 7 is a conceptual and schematic view of an example supercapacitive electrode array.

FIG. 8 is a conceptual and schematic top view of an example supercapacitive sensor array.

FIG. 9 is a photograph illustrating a comparative gel-based electrolyte layer cracking in response to deformation.

FIG. 10 is a photograph illustrating an example flexible electrolyte layer deformed without cracking.

FIG. 11 is a photograph illustrating another example flexible electrolyte layer having a spiral geometry.

FIG. 12 is a photograph illustrating an example flexible electrolyte layer having a ring geometry.

FIG. 13A is a photograph illustrating an example flexible electrolyte layer having an arched geometry.

FIG. 13B is a photograph illustrating an example flexible electrolyte layer having a dome geometry.

FIG. 14 is a photograph illustrating an example flexible electrolyte layer having a cylindrical geometry.

FIG. 15 is a photograph illustrating an example flexible electrolyte layer having a corrugated geometry.

FIG. 16 is a conceptual chart illustrating relationships between toughness, ultimate tensile strength, and maximum strain.

FIG. 17 is a chart illustrating measured stress-strain curves for an example flexible electrolyte and a comparative ionic-gel electrolyte.

FIG. 18 is a chart illustrating measured Young's modulus of example electrolytic elements in response to tensile cyclic loads at low frequencies.

FIG. 19A is a photograph illustrating a section of a filter paper dissolved in an example electrolytic composition.

FIG. 19B is a photograph illustrating a scanning electron microscope (SEM) image of surfaces of an undissolved section and a dissolved section of the filter paper of FIG. 19A.

FIG. 19C is a photograph illustrating an SEM image of surfaces of an undissolved section of the filter paper of FIG. 19A.

FIG. 19D is a photograph illustrating an SEM image of an interface between undissolved and dissolved sections of the filter paper of FIG. 19A.

FIGS. 20A and 20B are photographs illustrating SEM images of cross-sections of a filter paper after dissolution in an example electrolytic composition (at different magnification scales).

FIG. 21A is a photograph illustrating an exterior of an example supercapacitive sensor including a filter-paper based cylindrical flexible electrolyte.

FIG. 21B is a photograph illustrating an interior of the example supercapacitive sensor of FIG. 21A.

FIG. 22A is a photograph illustrating a top-view of an example supercapacitive sensor including a filter-paper based flexible electrolyte in a rolled-up configuration.

FIG. 22B is a photograph illustrating a side-view of the example supercapacitive sensor of FIG. 22A.

FIG. 23 is a photograph and a schematic illustration of an example supercapacitor sensor including a corrugated flexible electrolytic element applied on a urethral catheter.

FIG. 24 is a chart illustrating measured capacitance of an example supercapacitive sensor over time.

FIG. 25 is a photograph illustrating a paper-based flexible solid-state sensor element of a sensor array and a cloth based flexible solid-state sensor element.

FIG. 26 is a photograph illustrating a sensor array including a plurality of paper-based flexible solid-state sensor elements.

FIG. 27 is a chart illustrating measured sensitivity of an example supercapacitive sensor including a corrugated electrolyte.

FIG. 28 is a chart illustrating measured sensitivity of an example supercapacitive sensor including cloth-based electrolytic element.

FIG. 29A is a conceptual detail side view of an example article including a flexible solid-state electrolytic element in contact with roller electrodes.

FIG. 29B is a conceptual plan view of the example article of FIG. 29A.

FIG. 30A is a conceptual detail side view of an example article including two housing portions defining electrode openings and secured by pins and including a flexible solid-state electrolytic element in contact with roller electrodes.

FIG. 30B is an exploded plan view of the example article of FIG. 30A.

FIG. 31A is a conceptual cross-sectional side view of an example article including a cross-shaped flexible solid-state electrolytic element and an electrode array.

FIG. 31B is a partial bottom view of the cross-shaped flexible solid-state electrolytic element of FIG. 31A.

FIG. 31C is a partial top view of the electrode array of FIG. 31A.

FIG. 32A is a conceptual cross-sectional side view of an example article including an electrolytic array and an electrode array.

FIG. 32B is a partial bottom view of the electrolytic array of FIG. 32A.

FIG. 32C is a partial top view of the electrode array of FIG. 32A.

FIG. 33 is a chart illustrating a force response curve of a paper-based supercapacitive sensor outside and inside water.

FIG. 34 is a chart illustrating force response curves of a strain sensor with sensitivity at strains up to 25% extension.

FIG. 35 is a chart illustrating mechanical properties of an example nanoparticle-strengthened electrolytic film.

### DETAILED DESCRIPTION

Flexible electrolytes for supercapacitor-based sensors are described herein. As described herein, in a supercapacitor, the distance between the positive and negative charges at an electrode-electrolyte interface can be very small compared with conventional capacitors, and may be on the order of the size of 1 or 2 layers of atoms. Moreover, unlike conventional capacitor force sensors, the distance between electrodes typically does not significantly change in a supercapacitor-based sensor. Instead, in conventional supercapacitor-based force sensors, the contact area between the electrodes and an electrolytic fluid positioned between the electrodes changes in response to force. That is, a force on the electrodes typically causes the electrolytic fluid between the electrodes to be squeezed, resulting in a change in contact area between the electrolyte and the electrodes. This results in a change in capacitance, which serves as a measure of the applied force.

Various example implementations of supercapacitive force sensors are described herein that need not use liquid-based electrolytes. The disclosure describes various example supercapacitor-based force sensors that, rather than using only an electrolytic fluid between electrodes, may instead use one or more flexible solid-state electrolytic elements, either in place of the electrolytic fluid or in combination with the fluid. As described herein, the deformation of a flexible electrolytic element in response to an applied force changes the area of contact of the electrolyte with one or more electrodes of a supercapacitor. The resulting change in capacitance is indicative of the magnitude of the applied force and may be used to output an electronic signal indicative of the sensed force.

Supercapacitor-based force sensors constructed according to the disclosure may provide technical advantages, such as utilizing a construction that need not rely on liquid-based electrolytic elements contained between electrodes. For example, a flexible solid-state electrolytic element may be fabricated by applying a composition including an ionic liquid and a photo-curable prepolymer composition to a cellulosic material, for example, filter paper. The composition wets cellulosic structures and the wetted structure is photocured to obtain a flexible solid-state electrolytic element. The inclusion of the cellulosic structure changes mechanical properties of the composition, contributing to the flexibility of the electrolytic element. The phrase “flexible solid-state” refers to a solid, substantially solid, or gel-based structure capable of deforming without cracking in response to predetermined magnitudes of applied force and recovering to an initial geometry (within predetermined bounds of hysteresis) on removal of the applied force. In some examples, fabrication of devices including flexible solid-state electrolytic elements may be performed without requiring a clean-room environment.

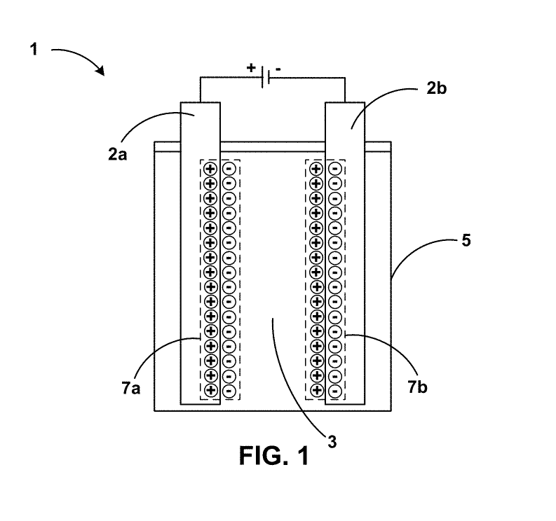

FIG. 1 is a schematic representation of a supercapacitor 1 including electrodes 2a and 2b in contact with an electrolytic solution 3. The application of a voltage across electrodes 2a and 2b enables the flow of ionic current between the electrodes, due to the presence of ions in electrolytic solution 3. A supercapacitor is governed by the same fundamental equation as a traditional capacitor in which capacitance (C) can be described by EQUATION 1.

$$C = \frac{ɛ A}{d} \qquad ( Equation 1 )$$

In EQUATION 1, A is the geometric capacitive surface area defined by the electrode, c is the relative permittivity of the dielectric material, and d is the distance between two oppositely biased electrodes. However, in a supercapacitor, the oppositely charged particles are separated from each other by a distance equal to just the size of 1 or 2 layers of atoms. This is because, as shown in FIG. 1, the positive and negative ions in electrolyte 3 separate from each other forming positive and negative layers of charges at the respective interfaces of negative and positive electrodes 2a and 2b with electrolyte 3. The electrode-electrolyte interface at each electrode of electrodes 2a and 2b results in double layers 7a and 7b formed between the electrolyte ions and the electronic charges on the respective electrodes 2a and 2b. Hence, din EQUATION 1 is the interplanar distance or the double layer atomic thickness, which is very small and of the order of Angstroms. Therefore, supercapacitors have significantly higher capacitances compared to traditional capacitors.

In conventional capacitor-based force sensors, the distance d between electrodes changes due to applied force. This results in a change in capacitance (according to EQUATION 1), and the measurement of capacitance provides a measure of the force exerted. In contrast, in supercapacitor 1, the distance between the positive and negative charges at each electrode does not change in response to force. Instead, the area A may be changed in response to force. In previous supercapacitor based sensors, the electrolyte is typically a liquid and the contact area between this liquid and the electrodes changes in response to force.

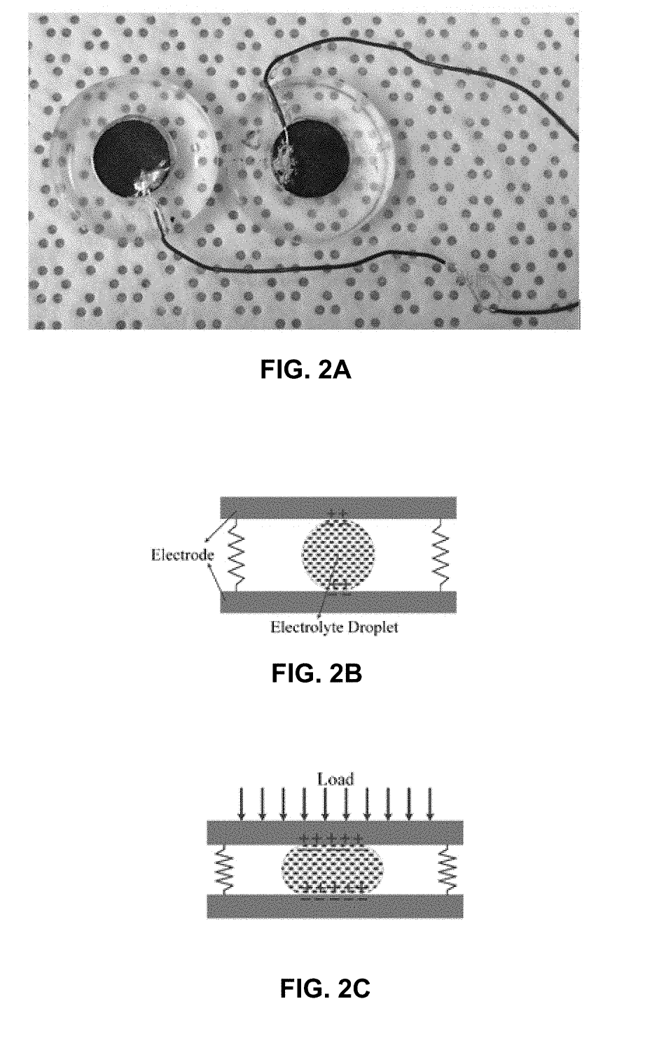

FIG. 2A is a photograph illustrating an example droplet-based supercapacitive sensor. FIG. 2B is a schematic side view of the droplet-based sensor of FIG. 2A at an initial state without load. FIG. 2C is a schematic side view of the sensor of FIG. 2B at a loaded state. The supercapacitive sensor of FIGS. 2A-2C includes a drop of electrolytic fluid which is squeezed between two electrodes. A force on the electrodes causes the drop to be squeezed, resulting in a change in the contact area between the electrolyte and the electrodes. This results in a change in capacitance, which serves as a measure of the applied force. However, to prevent the drop from dissipating or collapsing, the surface of the electrodes need to be treated, for example, to be superhydrophobic. Such treatment may prevent adhesion between the electrolyte and the electrodes, and allow a quick mechanical response of the droplet to applied force, without hysteresis.

The droplet-based supercapacitor of FIGS. 2A-2C and other supercapacitors including liquid electrolytes may suffer from some disadvantages. For example, the sensor cannot be miniaturized to create micro-sensors, because it may be difficult to create size-controlled micron sized droplets and to trap one inside a sealed sensor. Hydrophobic coatings may be expensive and entail a complex coating treatment process. Further, the presence of the coating reduces capacitance, because it increases the distance between the electrolyte and the electrode. Even in the case of relatively large-sized sensors, each sensor may need individual calibration to account for variability in droplet size and droplet location inside the sensor chamber. The larger size and higher costs may also pose problems in creating a sensor array for measuring distributed forces. The shelf life of a liquid-based sensor may be limited, due to atmospheric or ambient evaporation. The effect of gravity on the droplet may limit their application in systems involving non-planar motion.

Flexible solid-state electrolytic elements according to the disclosure may be used to form a supercapacitor-based force sensor, replacing the droplets or liquid electrolytes. The deformation of the flexible electrolyte in response to applied force and the resulting increase in its contact area with the electrodes may be used to sense force.

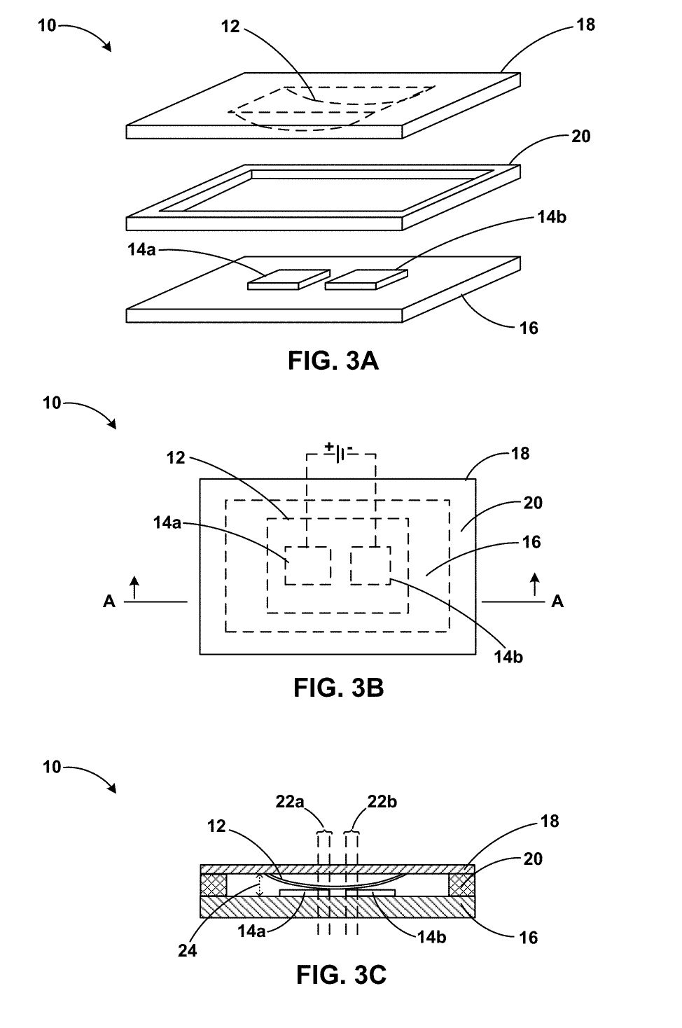

FIG. 3A is a conceptual and schematic exploded plan view of an example article 10 including a flexible solid-state electrolytic element 12. FIG. 3B is a conceptual and schematic top view of the example article of FIG. 3A. FIG. 3C is a conceptual and schematic cross-sectional view of the example article of FIG. 3A. In some examples, article 10 is a supercapacitive article. For example, a supercapacitor may include article 10. In some examples, a sensor, for example, a supercapacitive force sensor or strain sensor, may include article 10a.

Article 10 includes a positive electrode 14a, and a negative electrode 14b spaced apart from positive electrode 14a. In some examples, positive and negative electrodes 14a and 14b may be coplanar or otherwise adjacent along a plane, as shown in FIGS. 3A-3C. In other examples, positive and negative electrodes 14a and 14b may be disposed opposing each other, or angled with respect to each other, or at any other suitable geometric configuration in which flexible solid-state electrolytic element 12 may contact positive and negative electrodes 14a and 14b. Flexible solid-state electrolytic element 12 is adjacent to and positioned between positive and negative electrodes 14a and 14b. The term “flexible” indicates a recoverable change of shape in response to an applied force. In some examples, flexibility may be determined in terms of a Young's modulus of flexible solid-state electrolytic element 12. In some examples, flexible solid-state electrolytic element 12 has a Young's modulus of less than about 5 MPa, or less than about 4 MPa.

Flexible solid-state electrolytic element 12 is configured to exhibit a change in respective areas of contact 22a and 22b with positive and negative electrodes 14a and 14b in response to a force 24 applied on or between flexible solid-state electrolytic element 12 and positive and negative electrodes 14a and 14b. For example, the force may be applied to one or more of flexible solid-state electrolytic element 12 and positive and negative electrodes 14a and 14b. In some examples, the force is applied on flexible solid-state electrolytic element 12. In some examples, flexible solid-state electrolytic element 12 is spaced apart from positive and negative electrodes 14a and 14b in the absence of the applied force and in contact with positive and negative electrodes 14a and 14b in the presence of an applied force. In other examples, flexible solid-state electrolytic element 12 is in contact with positive and negative electrodes 14a and 14b in an initial configuration and continues to contact positive and negative electrodes 14a and 14b in the presence of an applied force. For example, flexible solid-state electrolytic element 12 may include a first portion adjacent to or in contact with positive electrode 14a and a second portion adjacent to or in contact with negative electrode 14b. The first portion and the second portion may each conform to curvatures that define respective areas of contact 22a and 22b with positive and negative electrodes 14a and 14b. For example, the first portion and the second portion may change respective areas of contact 22a and 22b with positive and negative electrodes 14a and 14b in response to the force. Areas of contact 22a and 22b between flexible solid-state electrolytic element 12 and positive and negative electrodes 14a and 14b respectively define a first and second capacitive double layer.

Positive and negative electrodes 14a or 14b may include one or more of a metal, an alloy, a conductive material (for example, a conductive polymer) or any suitable material capable of conducting or maintaining a capacitive charge. Positive and negative electrodes 14a or 14b may have the same composition, or different compositions. While positive and negative electrodes 14a and 14b may both have the same or similar shape, for example, as shown in FIGS. 3A-3C, in other examples, positive and negative electrodes 14a and 14b may have different shapes. While one or both of positive or negative electrodes 14a or 14b may define a rectangular surface, as shown in FIGS. 3A-3C, in other examples, positive or negative electrodes 14a or 14b may define any suitable shape, for example, a square, a rectangle, a triangle, a disc, a circle, an ellipsoid, any predetermined polygon, curved or complex-curved perimeter, a grid, mesh, and may be filled or unfilled. In some examples, positive or negative electrodes 14a or 14b may include metal or alloy foil adhered, attached, deposited, mounted to, or wrapped around, a substrate. In some such examples, the substrate may include paper.

As shown in FIG. 3C, force 24 may be applied on one or both of flexible solid-state electrolytic element 12 and positive and negative electrodes 14a and 14b. In some examples, positive and negative electrodes 14a and 14b may be held in a fixed configuration, and an applied force may deform flexible solid-state electrolytic element 12 resulting in a change in areas of contact 22a and 22b. For example, forcing or pressing flexible solid-state electrolytic element 12 towards positive and negative electrodes 14a and 14b may increase areas of contact 22a and 22b. In other examples, relieving force or pressure to release flexible solid-state electrolytic element 12 may move flexible solid-state electrolytic element 12 away from positive and negative electrodes 14a and 14b, reducing areas of contact 22a and 22b. The change in areas of contact 22a and 22b may change the capacitances of dual layers formed adjacent areas of contact 22a and 22b. This change in capacitance may be measured, for example, as a difference in electric potential between conductive leads in contact with electrodes 14a and 14b. Thus, article 10 may generate an electrical or electronic signal indicative of a force applied to article 10.

In some examples, one or both of flexible solid-state electrolytic element 12 and positive and negative electrodes 14a and 14b may be mounted to or secured to respective supports or supporting layers. As seen in FIGS. 3A and 3C, in some examples, article 10 may further include a base layer 16. One or both of positive and negative electrodes 14a and 14b may be mounted to or secured to base layer 16. For example, at least a portion of positive or negative electrodes 14a and 14b may be mounted to or secured to base layer 16. In some such examples, electrodes 14a and 14b are between base layer 16 and flexible solid-state electrolytic element 12.

In some examples, flexible solid-state electrolytic element 12 may be mounted or secured to a support layer 18. For example, one or more portions flexible solid-state electrolytic element 12 may be mounted or secured to support layer 18, while other portions of flexible solid-state electrolytic element 12 may be spaced from support layer 18. In some such examples, flexible solid-state electrolytic element 12 is between support layer 18 and positive and negative electrodes 14a and 14b. Flexible solid-state electrolytic element 12 may be biased away from support layer 18 towards positive and negative electrodes 14a and 14b. For example, flexible solid-state electrolytic element 12 may be biased to an arched configuration. In such examples, flexible solid-state electrolytic element 12 may assume the initial arched configuration in the absence of an applied force, and the arch may flatten or otherwise deform in response to an applied force, changing areas of contact 22a and 22b between flexible solid-state electrolytic element 12 and positive and negative electrodes 14a and 14b.

In some examples, article 10a includes a spacer layer 20 between base layer 16 and support layer 18. Spacer layer 20 may space positive and negative electrodes 14a and 14b from optional support layer 18. One or more of base layer 16, support layer 18, and spacer layer 20 may be made from any suitable material, for example, a polymeric material, paper, cloth, woven material, non-woven material, silicones, polydimethylsiloxane (PDMS) or glass. In some examples, one or more of base layer 16, support layer 18, and spacer layer 20 may be at least partially flexible or deformable, for example, in response to applied pressure. In some examples, one or more of base layer 16, support layer 18, and spacer layer 20 may be substantially rigid.

In some examples, flexible solid-state electrolytic element 12 includes a cellulosic material distributed in a cured ionic polymeric matrix. The cellulosic material may be any substrate including cellulosic fibers that may be filled, impregnated, or engorged with a liquid or gel prepolymer composition, or any substrate including cellulosic fibers that may be dispersed or distributed in the liquid or gel prepolymer composition. For example, the cellulosic material may include one or more of woven cellulosic fibers, nonwoven cellulosic fibers, paper, or cloth. The paper may include any suitable paper, including filter paper. Filter papers with different pore sizes (for example, between about 0.025 um and about 8 um) may be used to achieve flexible electrolytic elements with different mechanical properties. In some examples, the cellulosic material may be coated with the cured ionic polymeric matrix, instead of, or in addition to, being distributed in the cured ionic polymeric matrix. For example, the cured ionic polymeric matrix may form an ionic layer, and the cellulosic material may form a cellulosic layer adjacent to the ionic layer.

The cellulosic material may include organized or partially organized fibers, for example, as a grid, a mesh, a braid, a warp, a weft, or a weave, or may include randomly or isotropically oriented fibers, for example, fibers in a nonwowen fabric, batting, or mat. In some examples, instead of or in addition to cellulosic material, polymeric material (for example, fibers or granules) may be used.

In some examples, the cured ionic polymeric matrix may include a polymer formed by photocuring a photocurable composition comprising an ionic liquid, a prepolymer composition, and a photoinitiator. For example, the ionic liquid comprises 1-ethyl-3-methylimidazolium tricyanomethanide (EMIM-TCM). In some examples, the prepolymer composition includes polyethylene diacrylate (PEGDA) monomers. The photoinitiator may include 2-hydroxy-2-methylpropiophenone (HOMPP). Other suitable ionic liquids or photocurable polymers may also be used. In some examples, the photocurable composition may include 50 wt. % of the ionic liquid, about 40 wt. % of the prepolymer composition, and about 10 wt. % of the photoinitiator. The ratio of the components may be changed to adjust the mechanical properties of the electrolytic element. Electrolytic element 12 may be opaque, translucent, or transparent. In some examples, electrolytic element 12 is prepared from filter paper. In such examples, electrolytic element 12 may be transparent.

In some examples, the maximum elongation strain of the flexible solid-state electrolytic element may be further extended by adding nanoparticles to the ionic liquid before treating the cellulosic material with the polymer composition. Thus, in some examples, the cured ionic polymeric matrix may include nanoparticles. The nanoparticles may include any rigid material, for example, one or more of metal, alloy, ceramic, glass, or polymers. In some examples, the nanoparticles include silicate nanoparticles. Under stress, the nanoparticles in the polymer may tend to promote debonding of the polymer from the nanoparticles, creating local voids which may stop crack propagation. Additionally, instead of using paper or fabric, the cellulosic material may include cellulose microcrystalline powder could be used to make more complex 3-dimensional electrolyte geometries, like ball shaped or semi-sphere shaped electrolytes.

While flexible solid-state electrolytic element 12 is shown as having an arched configuration in example article 10 shown in FIGS. 3A-3C, in other examples, flexible solid-state electrolytic element 12 may include one or more of a planar sheet, an arched sheet, a corrugated sheet, a ring, a spiral, a coil, concave or convex curved plates, a scroll, or a cylinder.

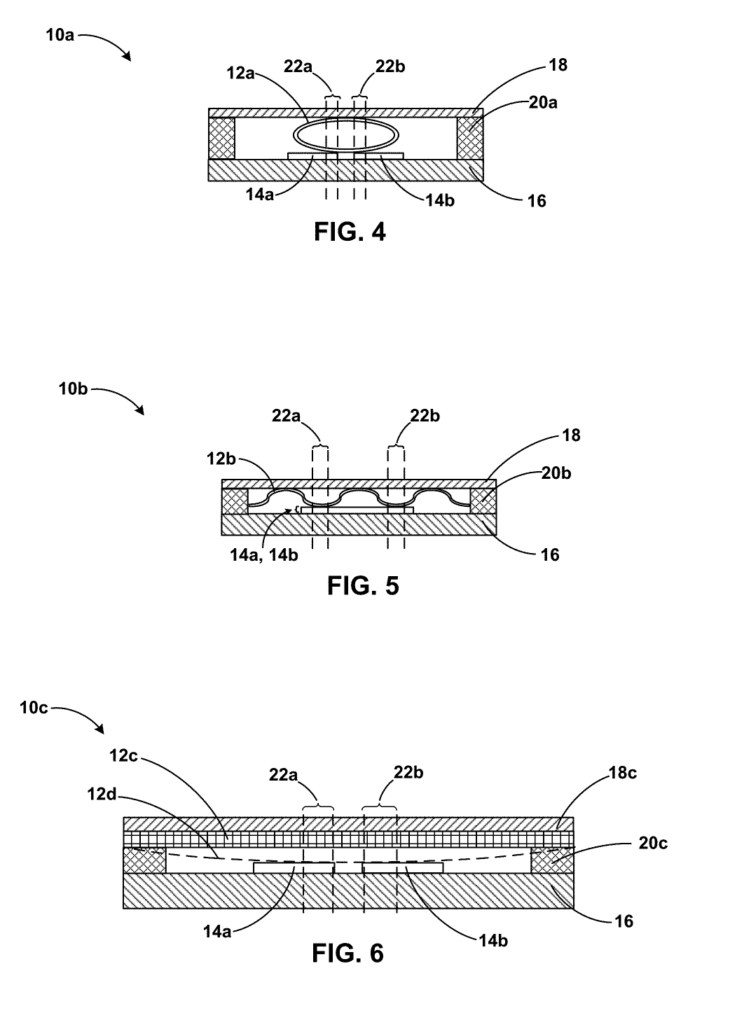

FIG. 4 is a conceptual and schematic cross-sectional view of an example article 10a including a cylindrical flexible solid-state electrolytic element 12a. Article 10a includes positive and negative electrodes 14a and 14b, and cylindrical flexible solid-state electrolytic element 12a is adjacent positive and negative electrodes 14a and 14b. Similar to article 10 of FIGS. 3A-3C, cylindrical flexible solid-state electrolytic element 12a is configured to contact positive and negative electrodes 14a and 14b at contact areas 22a and 22b, and contact areas 22a and 22b change in response to applied force. Article 10a may optionally include a spacer layer 20a to space positive and negative electrodes 14a and 14b from optional support layer 18. Cylindrical flexible solid-state electrolytic element 12a may be biased to an initial cylindrical configuration assumed in the absence of applied force. Cylindrical flexible solid-state electrolytic element 12a may progressively deform through a series of deformed cylindrical or quasi-cylindrical shapes in response to increasing applied force. The term “cylindrical” includes hollow tubes having circular or ellipsoidal cross-sections. In some examples, cylindrical flexible solid-state electrolytic element 12a may be substantially solid, instead of being hollow.

FIG. 5 is a conceptual and schematic cross-sectional view of an example article 10b including a corrugated flexible solid-state electrolytic element 12b. Article 10b includes positive and negative electrodes 14a and 14b, and corrugated flexible solid-state electrolytic element 12b is adjacent positive and negative electrodes 14a and 14b. Similar to article 10 of FIGS. 3A-3C, corrugated flexible solid-state electrolytic element 12b is configured to contact positive and negative electrodes 14a and 14b at contact areas 22a and 22b, and contact areas 22a and 22b change in response to applied force. Article 10b may optionally include a spacer layer 20b to space positive and negative electrodes 14a and 14b from optional support layer 18. Corrugated flexible solid-state electrolytic element 12b may be biased to an initial corrugated configuration assumed in the absence of applied force. Corrugated flexible solid-state electrolytic element 12b may progressively deform through a series of deformed or flattened corrugated shapes in response to increasing applied force. The term “corrugated” includes sinusoidal, undulating, or complex arcuate surfaces defining at least two peaks or two valleys. In some examples, corrugated flexible solid-state electrolytic element 12b may define at least two peaks, or at least three peaks, or at least five peaks. In some examples, corrugated flexible solid-state electrolytic element 12b may define at least two valleys, or at least three valleys, or at least five valleys. The orientation of the electrodes 14a and 14b may be parallel, perpendicular, or form a predetermined angle relative to the valleys of electrolytic element 12b. In the example shown in FIG. 5, electrodes 14a and 14b are both perpendicular to the valleys.

FIG. 6 is a conceptual and schematic cross-sectional view of an example article 10c including a flexible solid-state electrolytic element layer 12c applied to a substrate 18c. Substrate 18c may include a fabric or a 3d-printed soft flexible substrate. In some such examples, substrate 18c may function as a support layer, similar to support layer 18 of article 10 of FIGS. 3A-3C. Substrate 18c may include any suitable woven or nonwoven fabric, including one or more of cellulosic, paper, cloth, glass, polymer, or other fibers. In some examples, flexible solid-state electrolytic element layer 12c may be applied as a separate planar layer on a major surface defined by substrate 18c, as shown in FIG. 6. In other examples, flexible solid-state electrolytic element layer 12c may extend partly into or be embedded within fabric 18c. In some examples, article 10c may not include a separate substrate 18c, and flexible solid-state electrolytic element 12c itself may include a substrate. Similar to article 10 of FIGS. 3A-3C, flexible solid-state electrolytic element 12c is configured to contact positive and negative electrodes 14a and 14b at contact areas 22a and 22b, and contact areas 22a and 22b change in response to applied force. Article 10c includes a spacer layer 20c to space positive and negative electrodes 14a and 14b from optional support layer 18. Flexible solid-state electrolytic element 12c may be biased to an initial planar configuration assumed in the absence of applied force. Flexible solid-state electrolytic element 12c may progressively deform through a series of deformed or arched shapes 12d in response to increasing applied force, as shown in FIG. 5.

One or more of flexible solid-state electrolytic elements 12a, 12b, or 12c may be similar in composition to flexible solid-state electrolytic element 12. One or more of spacer layers 20a, 20b, or 20c may be similar in composition to spacer layer 20. One or more of articles 10, 10a, 10b, or, 10c may be provided with electrical leads electrically connected to one or more portions or components, for example to positive and negative electrodes 14a and 14b. The leads may be used to apply a predetermined electric potential or current, or to sense a change in potential or current in response to an applied force. In some examples, the same lead may be used to both apply and sense potential and current. In other examples, different leads may be used to apply and sense potential or current.

Thus, one or more of articles 10, 10a, 10b, or 10c may include a flexible solid-state element that exhibits a change in contact area with positive and negative electrodes to exhibit a change in a measurable electrical signal in response to an applied force. For example, one or more of articles 10, 10a, 10b, or 10c may be used as a force sensor. While each of articles 10, 10a, 10b, or 10c may include a single flexible solid-state electrolytic element, in other examples, articles according to the disclosure may include one or more flexible solid-state electrolytic elements. For example, example articles may include a plurality of flexible solid-state electrolytic elements, each of which is in contact with at least one positive electrode and one negative electrode. The plurality of flexible solid-state electrolytic elements may include one or more of flexible solid-state electrolytic element 12, flexible solid-state electrolytic element 12a, flexible solid-state electrolytic element 12b, flexible solid-state electrolytic element 12c, or any suitable flexible solid-state electrolytic element according to the disclosure. While each of articles 10, 10a, 10b, or 10c may include one pair of positive and negative electrodes, in some examples, example articles may include more than one pair of positive or negative electrodes, for example, an array of electrodes or segmented electrodes.

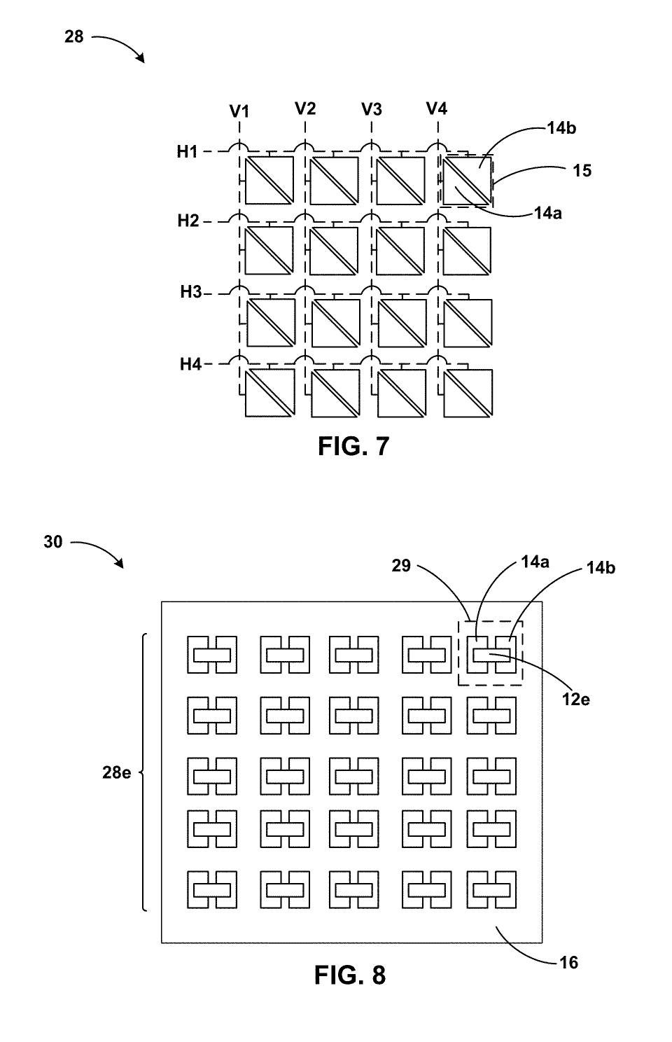

FIG. 7 is a conceptual and schematic view of an example supercapacitive electrode array 28. Supercapacitive electrode array 28 includes a plurality of electrode pairs 15. Each electrode pair of the plurality of electrode pairs includes positive and negatives electrodes 14a and 14b. In some examples, positive and negatives electrodes 14a and 14b of each electrode pair 15 may define substantially triangular surfaces. In other examples, positive and negatives electrodes 14a and 14b of each electrode pair 15 may define any suitable shape, for example, as described with reference to FIGS. 3A-3C. Each of positive and negatives electrodes 14a and 14b is connected to signal leads. For example, as shown in FIG. 7, signal buses may include positive signal lines V1, V2, V3, and V4 connected to positive electrodes 14a, and negative signal lines H1, H2, H3, and H4 connected to negative electrodes 14b. Thus, the signal lines may define an addressable array of electrodes, and changes in a sensed electrical parameter may be associated with a particular electrode pair of the plurality of electrode pairs 15. In some examples, supercapacitive electrode array 28 may be disposed adjacent a single flexible solid-state electrode element, and the single flexible solid-state electrode element may define respective contact areas with one or more electrode pair of the plurality of electrode pairs 15 in response to applied force at different locations across supercapacitive electrode array 28. In other examples, supercapacitive electrode array 28 may be disposed adjacent a plurality of flexible solid-state electrode elements, and one or more of the plurality of flexible solid-state electrode elements may each define contact areas at one or more electrode pair of the plurality of electrode pairs.

FIG. 8 is a conceptual and schematic top view of an example supercapacitive sensor array 30. Supercapacitive sensor array 30 includes a plurality of sensor cells 29. Each sensor cell 29 includes a flexible solid-state electrode element 12e, and positive and negative electrodes 14a and 14b. Positive and negative electrodes 14a and 14b define an electrode array 28e. Electrode array 28e may be the same as or similar to electrode array 28 described with respect to FIG. 7 or may have a different suitable geometry or configuration. For example, while positive and negative electrodes 14a and 14b in FIG. 8 define a rectangular surface, in other examples, they may define a triangular surface, as shown in FIG. 7, or any other suitable shape. Flexible solid-state electrode element 12e and positive and negative electrodes 14a and 14b in one or more sensor cells 29 may be the same as or similar in composition or geometry to flexible solid-state electrode elements and positive and negative electrodes described with reference to FIGS. 3A to 7. Supercapacitive sensor array 30 may include signal lines and signal buses similar to those described with reference to FIG. 7, and the sensed signals may be indicative of a force sensed by a particular sensor cell 29 within supercapacitive sensor array 30. Supercapacitive sensor array 30 may optionally include one or more of support layer 16, base layer 18, or spacer layer 20 as described with reference to FIGS. 3A-3C. One example application for such an array of sensors is a shoe insole force sensor, which can provide the force distribution of a human foot.

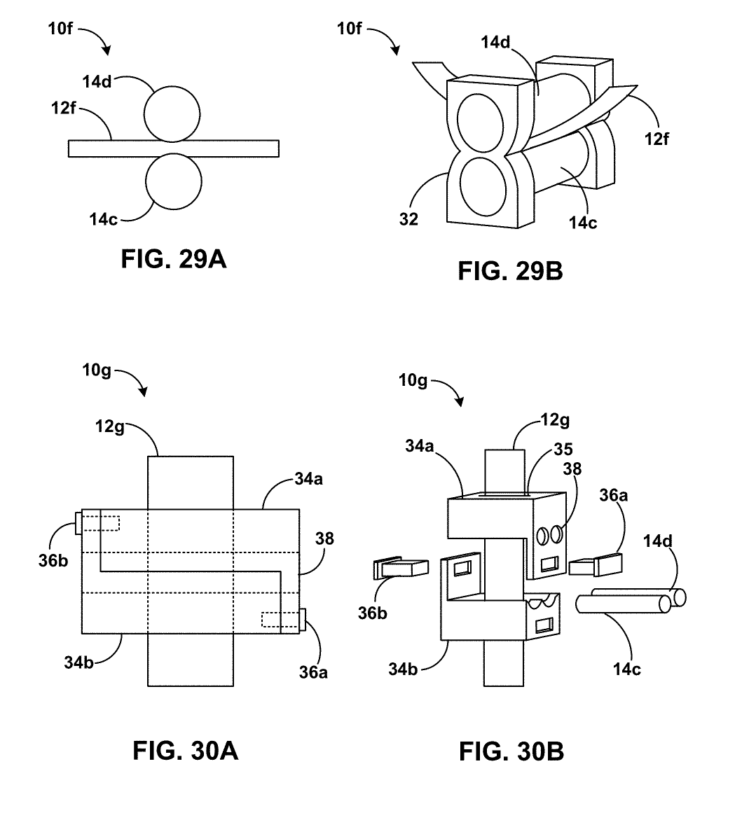

FIG. 29A is a conceptual detail side view of an example article 10f including a flexible solid-state electrolytic element 12f in contact with roller electrodes 14c and 14d. FIG. 29B is a conceptual plan view of article 10f of FIG. 29A. Roller electrodes 14c and 14d may be positive and negative electrodes, and may include metal or alloy pins, for example, stainless steel pins. In some examples, article 10f may function as a strain sensor, for example, by generating a signal indicative of strain experienced by electrolytic element 12f. For example, electrolytic element 12f may be in the form of a sheet or a thick-film electrolyte and may be pre-strained. Due to pre-strain in electrolytic element 12f, a tensile strain may reduce the contact area between electrolytic element 12f and electrodes 14c and 14d, which gives a measurable signal proportional to strain. In some examples, electrolytic element 12f includes silicate nanoparticles. Electrolytic element 12f may include a multi-layer electrolytic element. Electrolytic element 12f is compressed between roller electrodes 14c and 14d. Article 10f may include a housing 32 defining openings to mount electrodes 14c and 14d. The gap between electrodes 14c and 14d is smaller than a thickness of electrolytic element 12f. In some examples, the total thickness of electrolytic element 12f is 0.63 mm, while the gap between electrodes 14c and 14d is 0.44 mm. The gap may be lower than 10%, 20%, 30%, 40%, 50%, 60%, 70%, 80%, or 90% of the thickness of electrolytic element 12f.

FIG. 30A is a conceptual detail side view of an example article 10g including two housing portions 34a and 34b defining electrode openings 38 and secured by 36a and 36b pins and including a flexible solid-state electrolytic element 12g in contact with roller electrodes 14c and 14d. FIG. 30B is an exploded plan view of article 10g of FIG. 30A. Housing portions 34a and 34b, and pins 36a and 36b, may be additively manufactured, and may include any suitable polymeric material. Housing portions 34a and 34b may reduce or prevent sagging of electrolytic element 12g and hold electrolytic element 12g in a substantially straight configuration. In some examples, article 10g functions as a strain sensor, for example, by generating a signal indicative of strain experienced by electrolytic element 12g. In some examples, electrolytic element 12g may exhibit a change in surface area between electrolytic element 12g and electrodes 14c and 14d in response to strain and generate a measurable signal indicative of the strain.

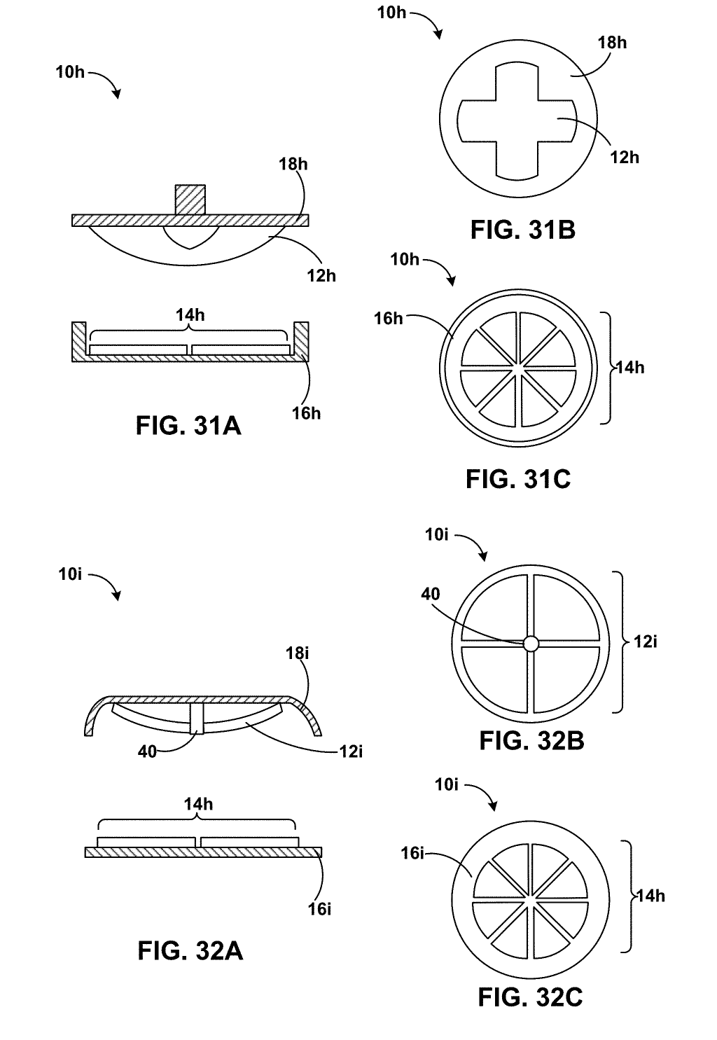

FIG. 31A is a conceptual cross-sectional side view of an example article 10h including a cross-shaped flexible solid-state electrolytic element 12h and an electrode array 14h. FIG. 31B is a partial bottom view of cross-shaped flexible solid-state electrolytic element 12h of FIG. 31A. FIG. 31C is a partial top view of electrode array 14h of FIG. 31A. Electrode array 14h may include pie-shaped electrode segments, for example, eight electrode segments, supported by support 16h, as shown in FIG. 31C. Electrolytic element 12h may be supported by support 18h. In some examples, support 18h includes or defines a dome, and electrolytic element 12g is disposed on the dome, such that the dome is between electrolytic element 12g and support 18h. In some examples, article 10h may function as a quad-unit shear force sensor cell. Electrode array 14h includes four force sensors including two electrodes each. Electrodes of electrode array 14a may be patterned in such a way that the four sensors lie symmetrically on the axes of a Cartesian coordinate system with the center of the eight electrodes sitting at the origin. The four capacitance readings (C1, C2, C3, C4) of the four sensors (S1, S2, S3, S4) are used to estimate the normal force and shear force applied on the sensing cell. For example, the normal force is obtained from the average of the four force sensors by EQUATION 2:

Fₙ=¼(K₁C₁+K₂C₂+K₃C₃+K₄C₄) (Equation 2)

where K₁, K₂, K₃ and K₄ are the calibration coefficients between force and capacitance of each sensor. The shear force along the x axis is given by EQUATION 3:

Fₓ=|K₁C₁−K₃C₃| (Equation 3),

while the shear force along the y axis is given by EQUATION 4.

F_{y}=|K₂C₂−K₄C₄| (Equation 4)

FIG. 32A is a conceptual cross-sectional side view of an example article 10i including an electrolytic array 12i and electrode array 14h. FIG. 32B is a partial bottom view of electrolytic array 12i of FIG. 32A. FIG. 32C is a partial top view of electrode array 14h of FIG. 32A. Article 10i may include a pillar 40. Article 10i may function as a quad-unit force sensor, similar to article 10h of FIGS. 31A-31C. Electrolytic array 12i may be supported by support 18i, while electrode array 14h may be supported by support 16i. In some examples, support 18i includes or defines a dome, and electrolytic array 12i is disposed on the dome, such that the dome is between electrolytic array 12i and support 18i.

One or more components of articles 10f, 10g, 10h, or 10i may be formed by additive manufacturing (also known as 3D printing), and may include one or more of metal, alloy, glass, polymer, ceramic, or any suitable substrate.

Example techniques for preparing one or more articles according to the disclosure are described. However, any suitable example technique may be prepared by any suitable technique. In some examples, an example technique forming a flexible solid-state electrolytic element includes wetting a cellulosic material with a photocurable composition including an ionic liquid, a prepolymer composition, and a photoinitiator. The example technique includes photocuring the photocurable composition for a predetermined curing period by exposing the wetted cellulosic material to a predetermined curing wavelength of light. In some examples, the ionic liquid includes 1-ethyl-3-methylimidazolium tricyanomethanide (EMIM-TCM). In some examples, the prepolymer composition comprises polyethylene diacrylate (PEGDA) monomers. In some examples, the photoinitiator includes 2-hydroxy-2-methylpropiophenone (HOMPP). In some examples, the photocurable composition includes about 50 wt. % of the ionic liquid, about 40 wt. % of the prepolymer composition, and about 10 wt. % of the photoinitiator.

In some examples, the example technique includes, before the photocuring, forming the cellulosic material in a predetermined geometry. For example, the forming may include placing the cellulosic material in a mold, wetting the cellulosic matrix with the photocurable composition in or on the mold, and photocuring the photocurable composition in the mold. In some examples, the predetermined curing period lasts for at least about 60 seconds. In some examples, the predetermined curing period lasts for at less than about 5 minutes, or less than about 2 minutes, or less than about 90 seconds, or less than about 60 seconds, or less than about 30 seconds. The cellulosic material may optionally be formed by applying mechanical forces or twist, bend, stretch, or otherwise deform an initial configuration of the cellulosic material, for example, to form one or more of a flat sheet, an arched sheet, a corrugated sheet, a ring, a spiral, a coil, a cylinder, or any other suitable shape.

Flexible solid-state electrolytic elements according to the disclosure may be used to form sensors. In some examples, an example technique of manufacturing a sensor includes forming flexible solid-state electrolytic element 10, 10a, 10b, 10c, or another flexible solid-state electrolytic element according to the disclosure. The example technique includes arranging the flexible solid-state electrolytic element between a positive electrode and a negative electrode such that the flexible solid-state electrolytic element is adjacent to or in contact with both the positive electrode and the negative electrode.

Example articles and sensors including flexible solid-state electrolytic elements and example techniques for forming flexible solid-state electrolytic elements are described. Sensors according to the disclosure may have a relatively low cost, and be relatively simpler to fabricate, compared to conventional sensors. Flexible solid-state electrolytic elements according to the disclosure may be sufficiently flexible to be shaped into low-stiffness structures, which may show considerable deformation in response to force, without cracking or breaking. Such electrolytic elements may not adhere to surfaces, for example, the surfaces of copper or other metal or alloy electrodes and other surfaces of sensors, allowing the electrolytic element to recover its original shape when force applied on it is withdrawn.

The present disclosure will be illustrated by the following non-limiting examples.

### EXAMPLES

### Comparative Example 1

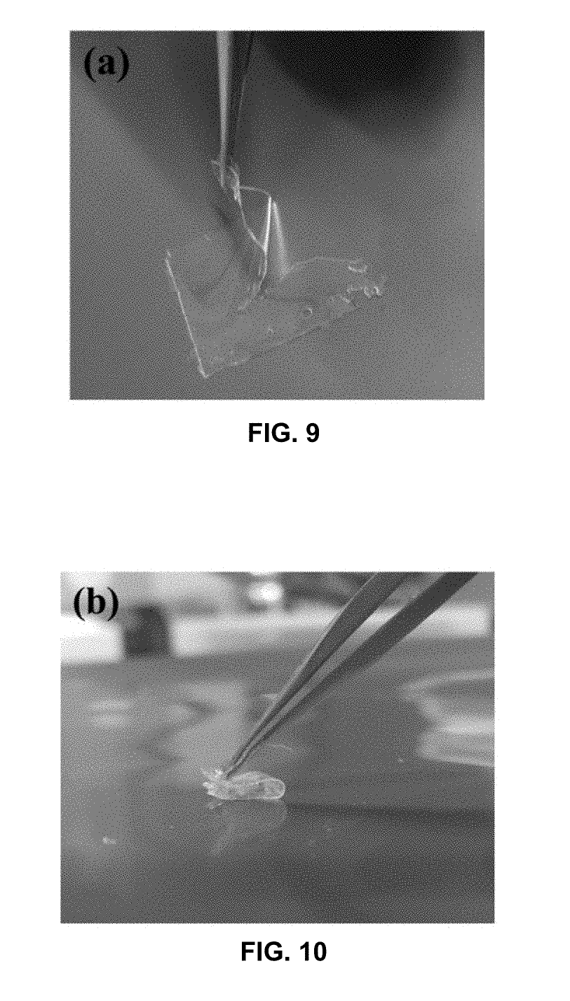

A layer of a gel-based electrolyte was prepared. The sheet was prepared by applying a coating including a prepolymer solution and an ionic liquid, and photocuring the sheet. The ionic liquid was 1-ethyl-3-methylimidazolium tricyanomethanide (EMIM-TCM) (IOLITEC Inc., New York, N.Y.). The prepolymer solution included polyethyleneglycol diacrylate (PEGDA, Mw=575 g mol−1) monomers (Sigma-Aldrich St. Louis, Mo.) and a photo initiator of 2-hydroxy-2-methylpropiophenone (HOMPP) (Sigma-Aldrich, St. Louis, Mo.) were mixed in a ratio of 50:40:10% by weight. The mixed gel was drop-casted on to a flat mold, the mold was covered with a glass slide, and exposed under UV light for 1 minute. FIG. 9 is a photograph illustrating the comparative gel-based electrolyte layer cracking in response to deformation. As seen in FIG. 9, the layer had limited flexibility.

### Example 1

An example flexible solid-state electrolytic element was fabricated. A mixed gel was prepared as described in COMPARATIVE EXAMPLE 1. The mixed gel was then brushed on to a HATF MF-Millipore filter paper (0.45 um) (Millipore, Burlington, Mass.). The brushed paper was cured for 1 min by UV exposure (wavelengths 300 to 400 nm) to obtain a flexible solid electrolyte sheet. FIG. 10 is a photograph illustrating an example flexible electrolyte layer deformed without cracking. As seen in FIG. 10, the flexible solid-state electrolytic element was deformable and conformable.

### Example 2

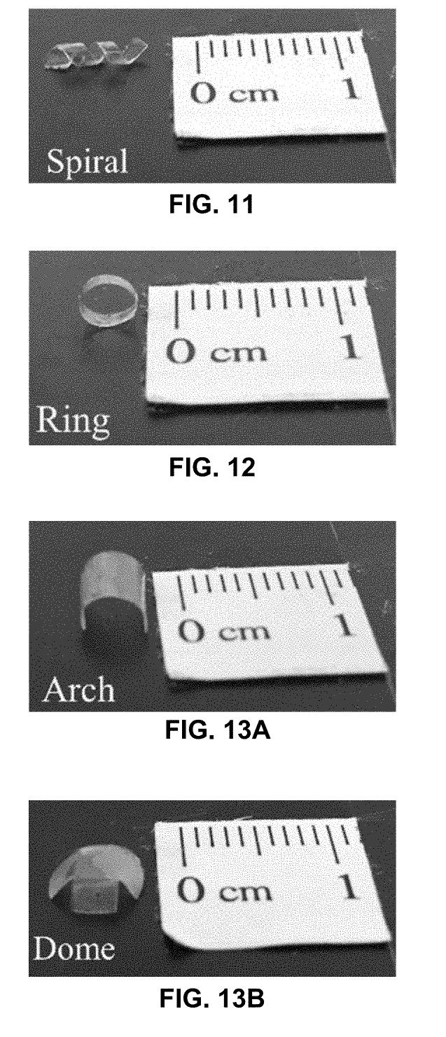

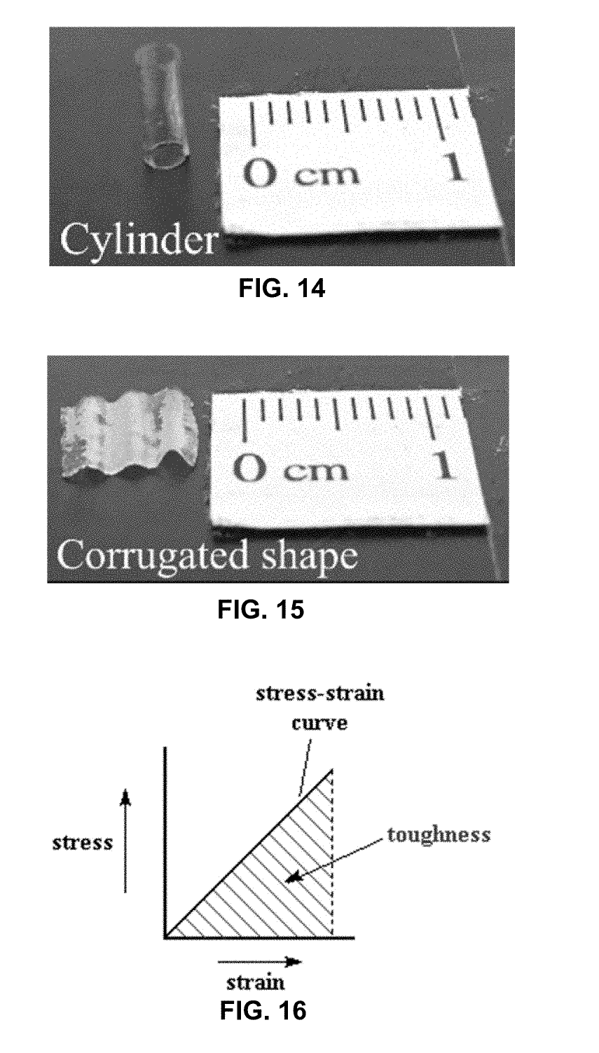

Different shapes for example flexible solid-state electrolytic elements were fabricated. A mixed gel was prepared as described in EXAMPLE 1. The mixed gel was then brushed on to the filter paper in different shapes, and then cured as described in EXAMPLE 1. FIG. 11 is a photograph illustrating an example flexible electrolyte layer having a spiral geometry. FIG. 12 is a photograph illustrating an example flexible electrolyte layer having a ring geometry. FIG. 13A is a photograph illustrating an example flexible electrolyte layer having an arched geometry. FIG. 13B is a photograph illustrating an example flexible electrolyte layer having an arched geometry. FIG. 14 is a photograph illustrating an example flexible electrolyte layer having a cylindrical geometry. FIG. 15 is a photograph illustrating an example flexible electrolyte layer having a corrugated geometry.

### Example 3

The flexibility and mechanical behaviour of the flexible solid-state electrolytic element of EXAMPLE 1 was characterized. FIG. 16 is a conceptual chart illustrating relationships between toughness, ultimate tensile strength, and maximum strain. A seen in FIG. 16, the toughness of a material is the area under its stress-strain curve. The ultimate tensile strength is the maximum stress before failure and the maximum elongation strain is the strain the material undergoes just before failure under a tensile load.

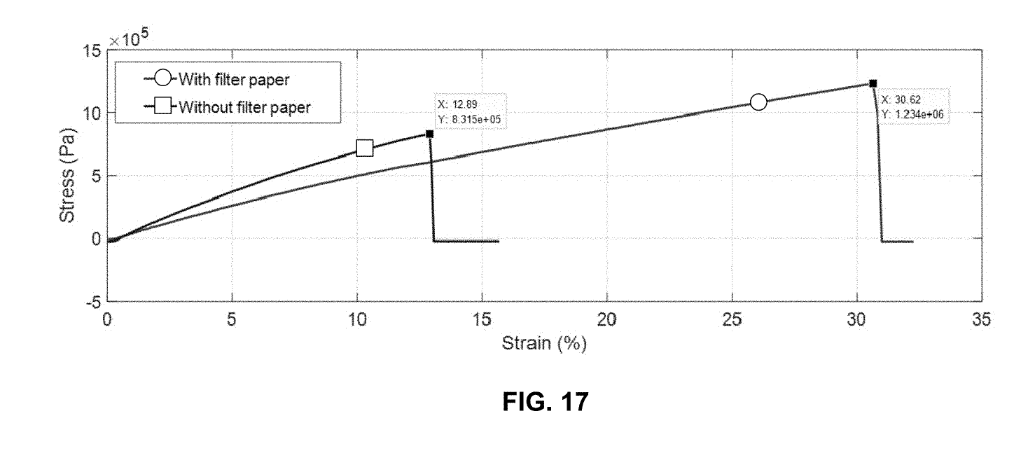

Thin film electrolytes without and with the filter paper (prepared according to COMPARATIVE EXAMPLE 1 AND EXAMPLE 1) were stretched under tensile forces using a DMA (dynamic mechanical analysis) machine and the stress-strain curves were measured. FIG. 17 is a chart illustrating measured stress-strain curves for an example flexible electrolyte and a comparative ionic-gel electrolyte. As seen in FIG. 17, the ultimate tensile strength is 50% larger, the toughness is 3.55 times higher and the maximum elongation strain is 2.5 times larger for the flexible solid-state electrolyte according to EXAMPLE 1 compared with the gel-based electrolyte according to COMPARATIVE EXAMPLE 1.

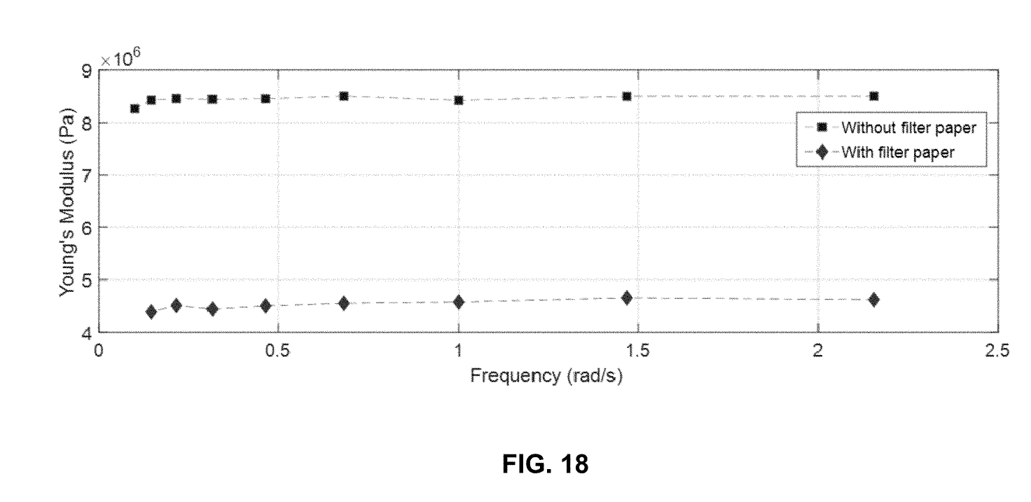

The Young's modulus of the electrolytes according to COMPARATIVE EXAMPLE 1 and EXAMPLE 1 were determined and compared using cyclic tensile loads at low frequencies. FIG. 18 is a chart illustrating measured Young's modulus of example electrolytic elements in response to tensile cyclic loads at low frequencies. As seen in FIG. 18, the Young's modulus of the flexible solid-state electrolytic element according to EXAMPLE 1 is approximately half of the Young's modulus for the gel-based electrolyte according to COMPARATIVE EXAMPLE 1.

### Example 4

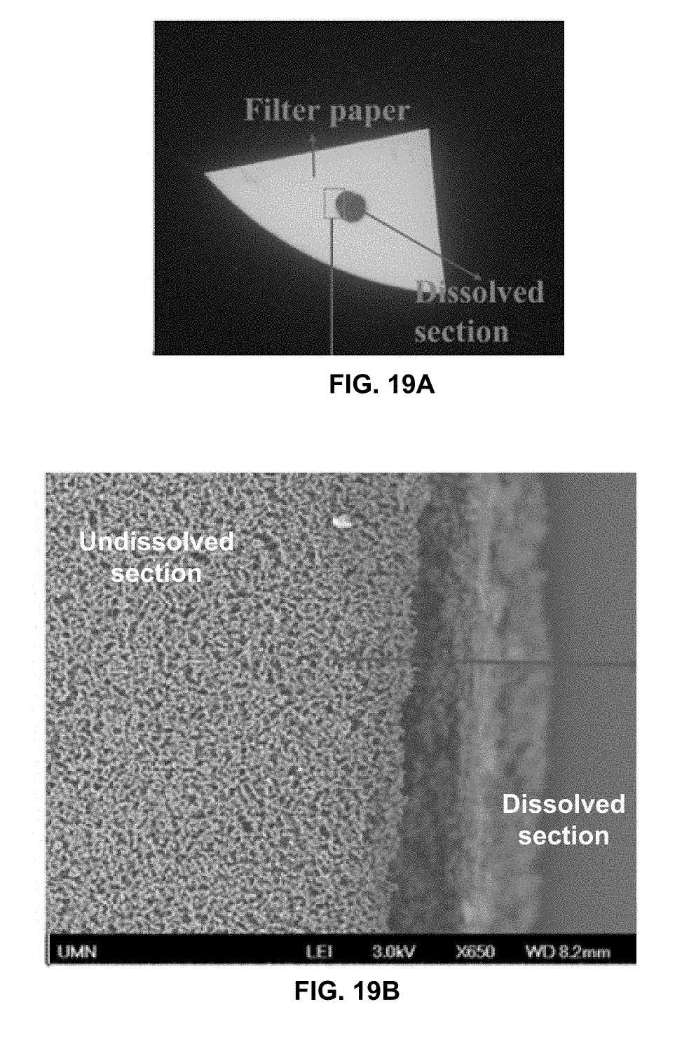

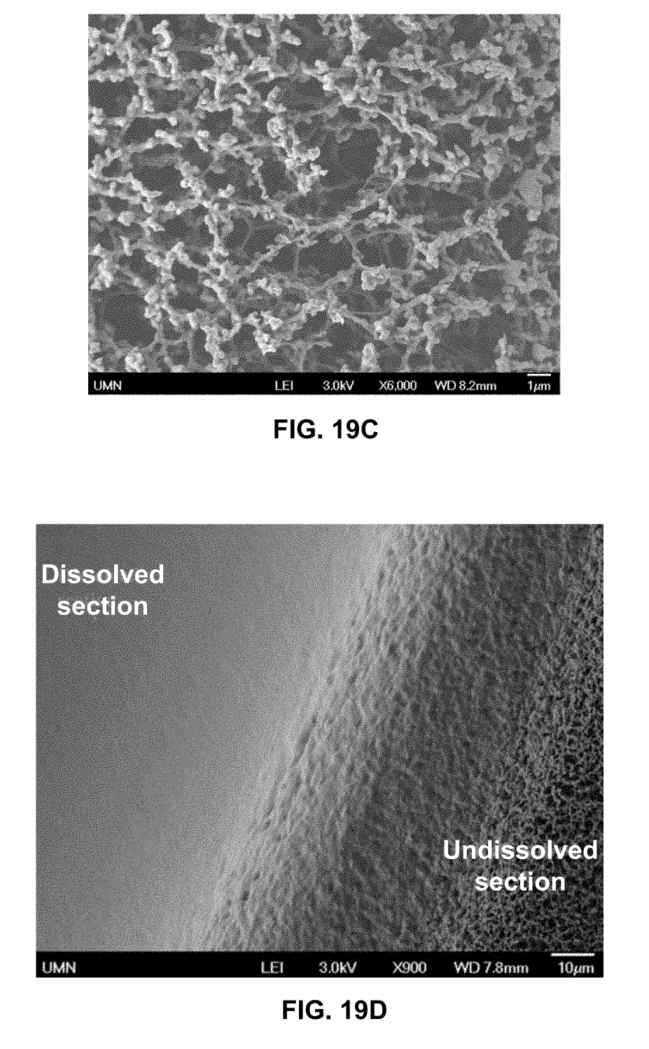

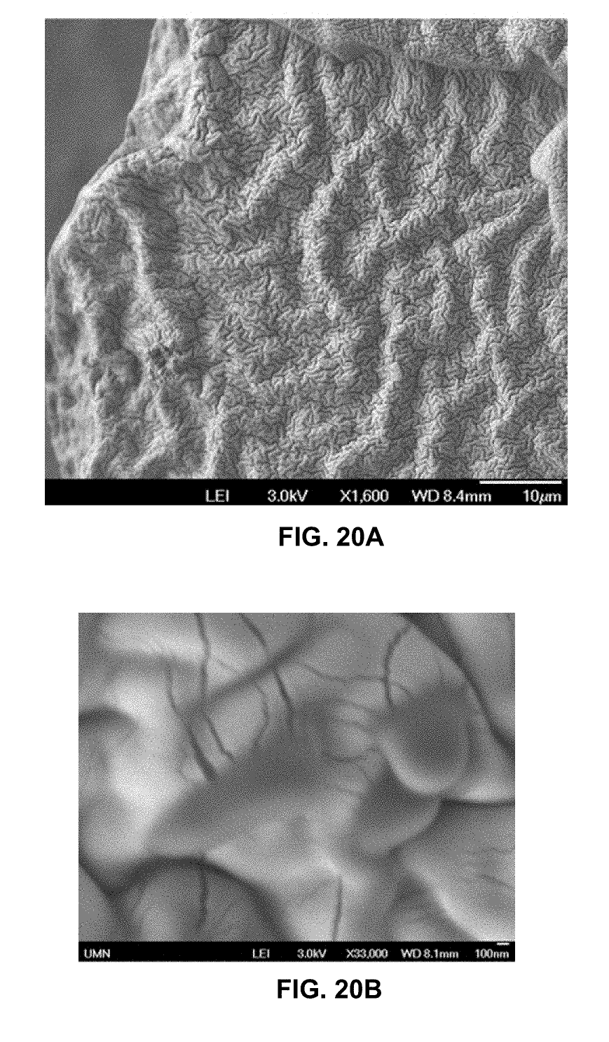

The microstructure of the gel-based electrolyte of COMPARATIVE EXAMPLE 1 and the flexible solid-state electrolyte of EXAMPLE 1 were compared. FIG. 19A is a photograph illustrating a section of a filter paper dissolved in an example electrolytic composition. FIG. 19B is a photograph illustrating a scanning electron microscope (SEM) image of surfaces of an undissolved section and a dissolved section of the filter paper of FIG. 19A. FIG. 19C is a photograph illustrating an SEM image of surfaces of an undissolved section of the filter paper of FIG. 19A. FIG. 19D is a photograph illustrating an SEM image of an interface between undissolved and dissolved sections of the filter paper of FIG. 19A. FIG. 20A and FIG. 20B are photographs illustrating SEM images of cross-sections of a filter paper after dissolution and ultraviolet (UV) exposure in an example electrolytic composition (at different magnifications).

As seen in FIGS. 20A and 20B, the dissolved filter paper has many “wrinkles” in its cross-section. These wrinkles are created by dissolution of the structures in the filter papers. The wrinkles were not observed in the cross section of the raw filter paper and were not observed in gel-based electrolyte without the filter paper according to COMPARATIVE EXAMPLE 1. Without being bound by theory, the wrinkles are expected to be responsible for the higher flexibility of the flexible solid-state electrolyte according to EXAMPLE 1.

### Example 5

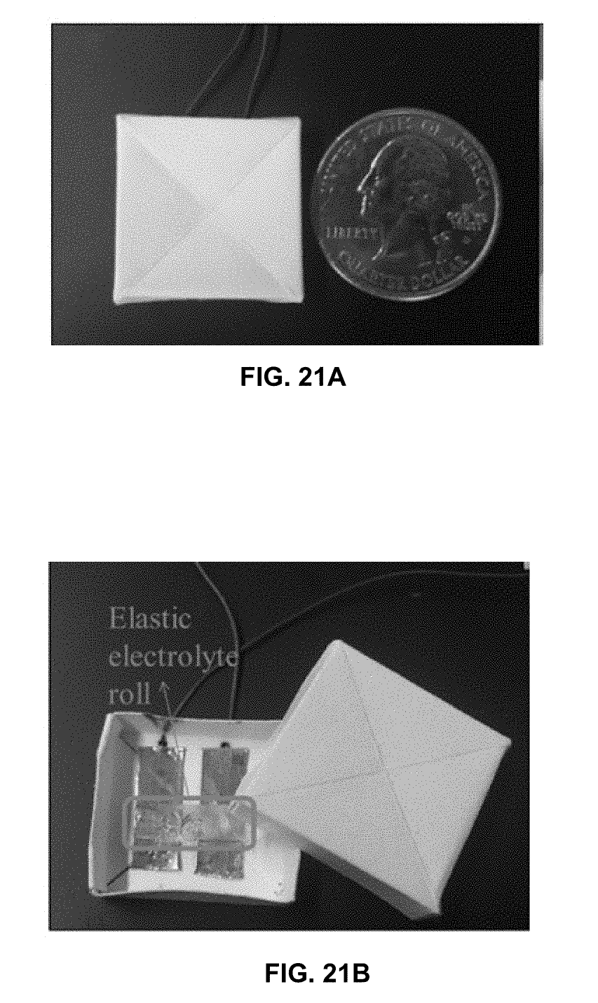

A sensor including a cylindrical flexible solid-state electrolytic element was prepared. FIG. 21A is a photograph illustrating an exterior of an example supercapacitive sensor including a filter-paper based cylindrical flexible electrolyte. FIG. 21B is a photograph illustrating an interior of the example supercapacitive sensor of FIG. 21A. A planar set of two copper electrodes was placed on a paper substrate and a cylindrical electrolyte was placed on top of the electrode pair. The copper electrodes were made by using copper tape and sticking them on paper.

### Example 6

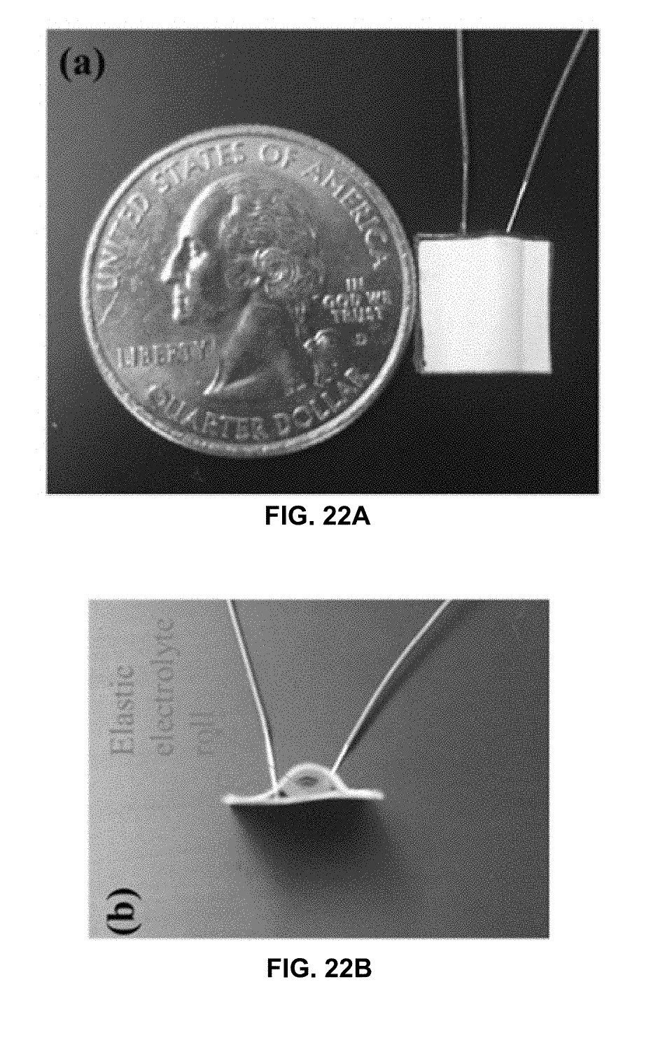

A sensor including a rolled flexible solid-state electrolytic element was prepared. FIG. 22A is a photograph illustrating a top-view of an example supercapacitive sensor including a filter-paper based flexible electrolyte in a rolled-up configuration. FIG. 22B is a photograph illustrating a side-view of the example supercapacitive sensor of FIG. 22A. Two pieces of paper were glued together with one on top bent into an arch shape. An electrolyte roll was placed on top of two parallel copper electrodes.

### Example 7

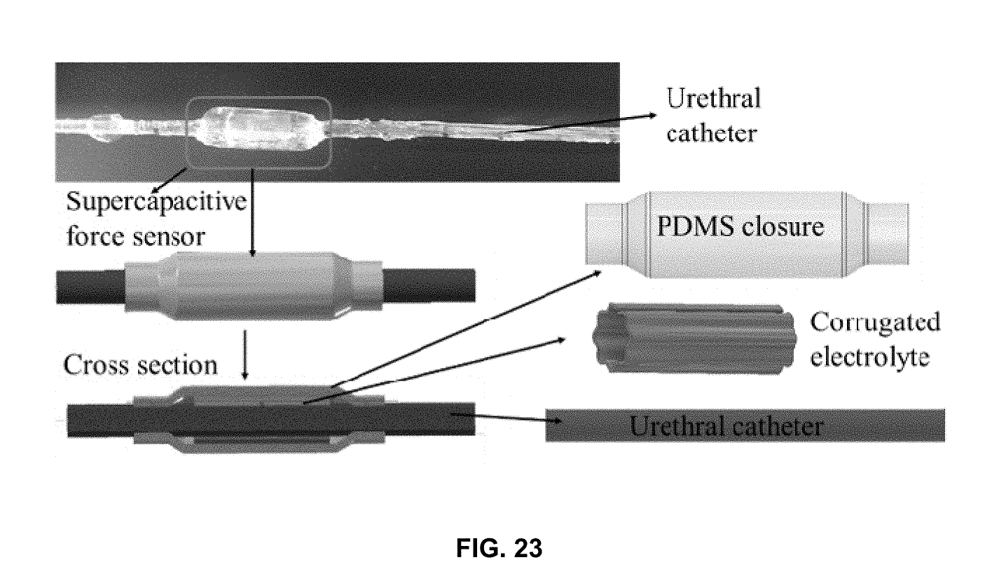

A supercapacitor-based sensor was fabricated on a biomedical catheter, in particular, a urethral catheter. FIG. 23 is a photograph and a schematic illustration of an example supercapacitor sensor including a corrugated flexible electrolytic element applied on a urethral catheter. A corrugated shaped electrolyte was wrapped around a catheter (2.3 mm in diameter) and enclosed inside a polydimethylsiloxane (PDMS) case. The force sensors on the catheter can measure the closure force in body cavities, blood vessels and interface pressure in organs such as the urethra. During clinical examination, the instrumented urethral catheter may be inserted by a clinician through the urethra so that its tip is in the bladder. The supercapacitive force sensor installed may be used to measure the distributed force inside the urethral (omni-directional). For example, the instrumented urethral catheter may be used to diagnose the cause of urinary incontinence (leakage) in patients helping diagnose the patient-specific cause of incontinence in clinical applications.

### Example 8

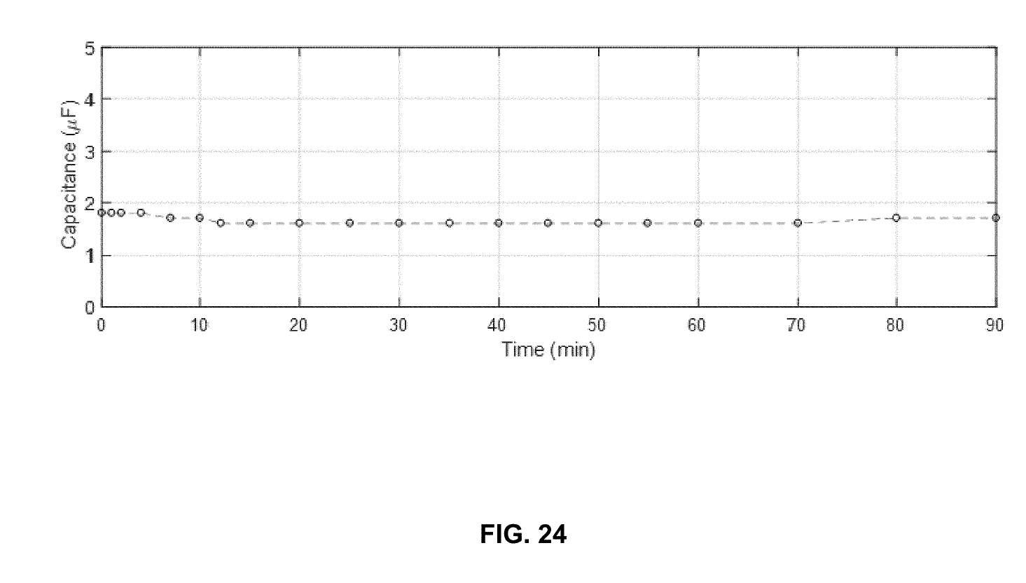

The sensor time-drift performance of a sensor including a flexible solid-state electrolytic element according to EXAMPLE 1 was characterized. FIG. 24 is a chart illustrating measured capacitance of an example supercapacitive sensor over time. As seen in FIG. 24, the capacitance change of a sensor under a static weight over 90 mins of time did not show any drifting at all. This result indicates that the sensor can be used without pre-calibration for absolute measurement of force.

### Example 9

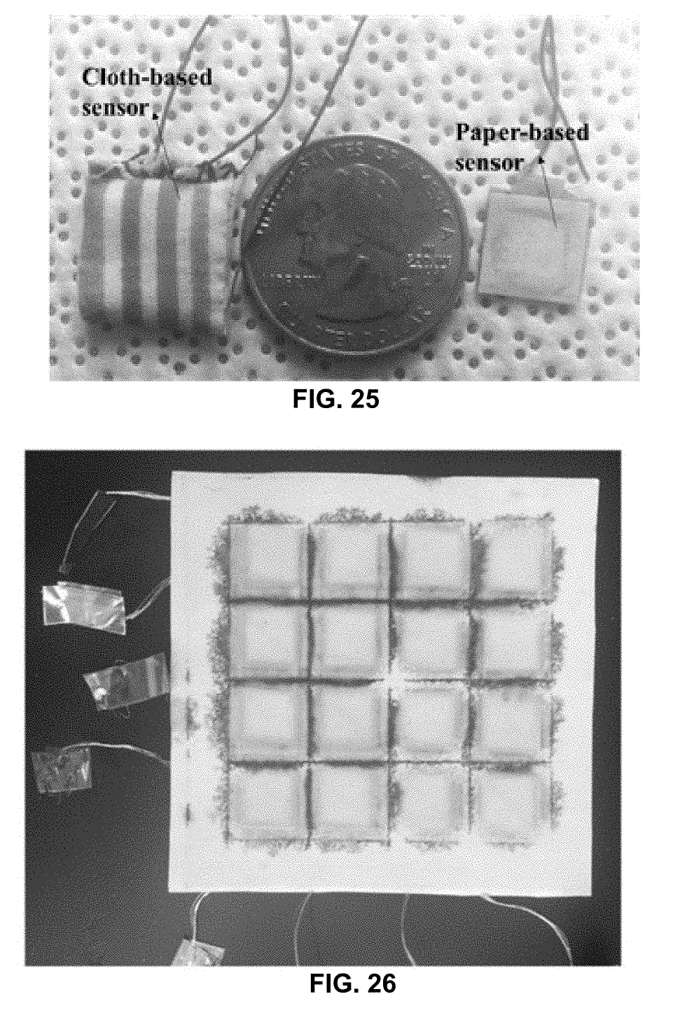

Sensor elements and array of force sensors were prepared. FIG. 25 is a photograph illustrating paper-based and cloth-based flexible solid-state sensor elements in sensors. FIG. 26 is a photograph illustrating a sensor array including a plurality of paper-based flexible solid-state sensor elements. As seen in FIG. 26, paper-based flexible solid-state sensor element sensors (as shown in FIG. 25) were arranged into a 4 by 4 sensor matrix.

### Example 10

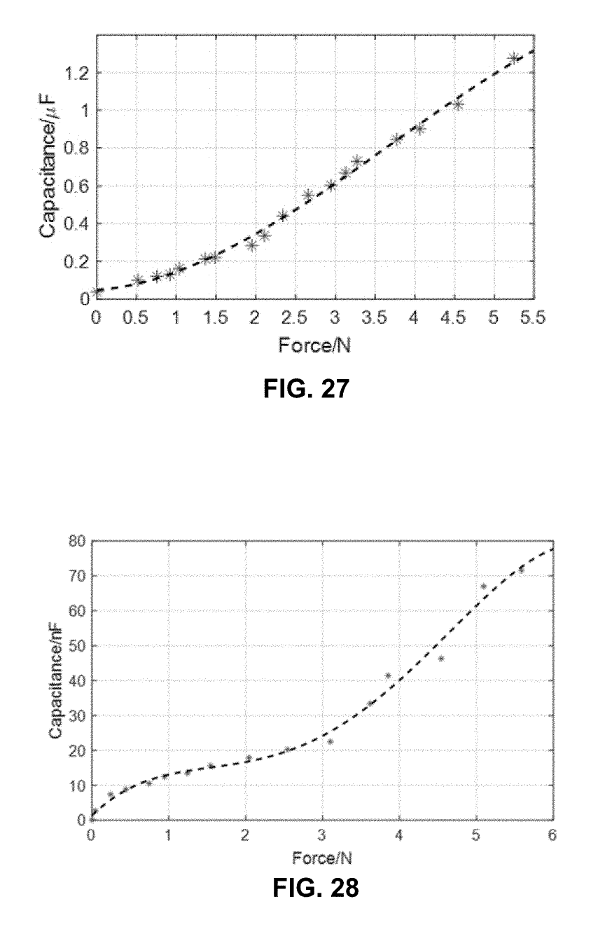

The sensitivity of a sensor including a flexible solid-state electrolytic element according to EXAMPLE 1 was characterized. Without being bound by theory, the sensitivity of the supercapacitive sensors may depends on the size and configuration of the sensors, ranging from nF/N to μF/N, based on the sensor size. This should be compared to typical sensitivities of pF/N for traditional capacitive sensors. FIG. 27 is a chart illustrating measured sensitivity of an example supercapacitive sensor including a corrugated electrolyte disposed between support and base layers made of PDMS. A spacer layer made of PDMS was used to space apart the support and base layers. The supercapacitive sensor including the flexible solid-state electrolytic element had a sensitivity 6 orders of magnitude larger compared to traditional capacitive sensors. The sensitivity of this sensor is around 0.4 μF/N. FIG. 28 is a chart illustrating measured sensitivity of an example supercapacitive sensor including the cloth-based electrolytic element of EXAMPLE 9 (shown in FIG. 25). Ionic gel was brushed onto cloth. The cloth got partially dissolved and the rest of the structure held the ionic gel. As seen in FIG. 28, the sensitivity is about 20nF/N.

### Example 11

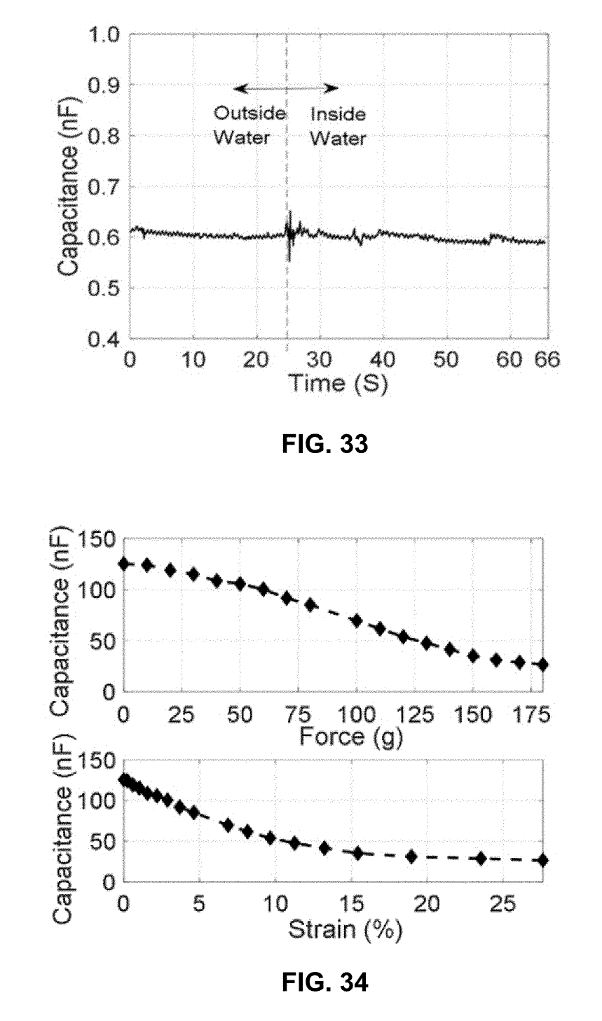

The effect of water on example electrolytic elements was determined. FIG. 33 is a chart illustrating a force response curve of a paper-based supercapacitive sensor outside and inside water. The capacitance increases by a small amount ranging from 1 pF-10 pF, starting from a base capacitance of 600 pF, which includes variations from instrument errors. This increase in capacitance in the presence of water is negligible compared to the ultra-high sensitivity of the sensor at ˜20 nF/N. Supercapacitive sensors do not suffer from parasitic noise. In a supercapacitor, the distance between the positive and negative charges at each electrode is of the order of the size of one or two atomic layers. Hence, the fringe fields are negligible.

### Example 12

The relation between the applied force and the resultant capacitance and between the strain of the electrolyte and the capacitance was evaluated. FIG. 34 is a chart illustrating force response curves of a strain sensor with sensitivity at strains up to 25% extension. As the applied forces increases, the capacitance decreases due to the thinning of the electrolyte film, which leads to smaller contact area between the electrode pins and the electrolyte. Above a strain of ˜25%, the capacitance saturates due to the thickness of the film becoming close to the gap between the two electrode pins.

### Example 13

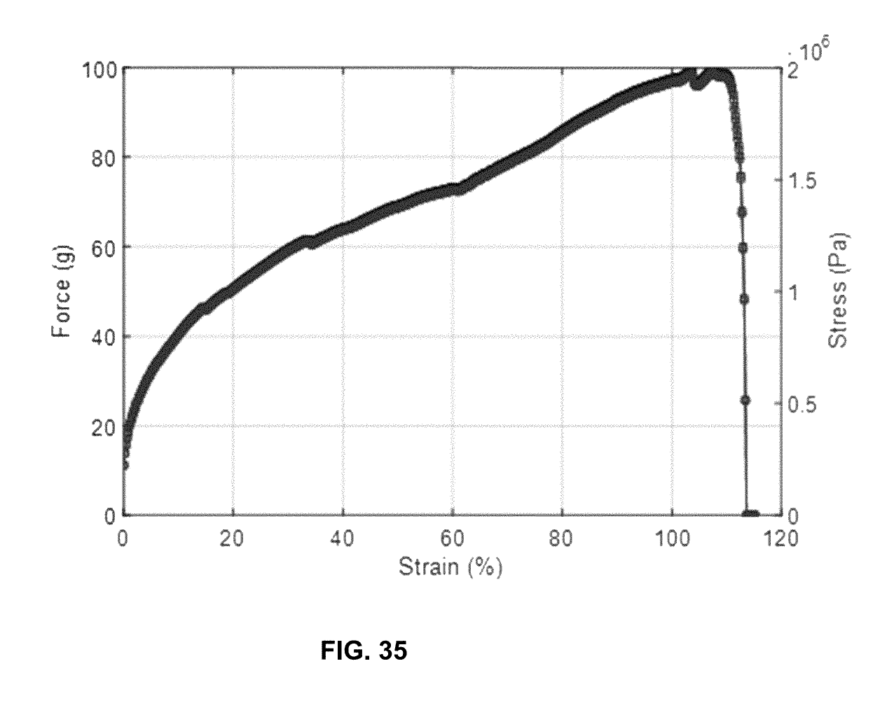

The effect of adding nanoparticles of ionic liquid used to prepare electrolytic elements was evaluated. The maximum elongation strain of the paper-based electrolyte can be further extended by adding nanoparticles to the ionic liquid. Without being bound by theory, under stress, the presence of nanoparticles may promote the debonding of the polymer from the nanoparticles, creating local voids that dissipate energy and stop crack propagation. A highly extensible and tough film of paper-based electrolytes was synthesized using silicate nanoparticles, which could be stretched to more than 100% strain before failure. FIG. 35 is a chart illustrating mechanical properties of the example nanoparticle-strengthened electrolytic film. The Young's modulus of the strengthened electrolyte film is increased to 14MPa. As seen in FIG. 35, the electrolyte can be stretched to over 100% tensile strain before failure occurs. By changing the ratio of silicate nanoparticles added to the electrolyte, the mechanical properties of the electrolyte film can be variably adjusted.

Various examples have been described. These and other examples are within the scope of the following claims.

What is claimed is:

1. An article comprising:
a positive electrode;
a negative electrode spaced apart from the positive electrode; and
a flexible solid-state electrolytic element adjacent to and positioned between the positive and negative electrodes,
wherein the flexible solid-state electrolytic element is configured to deform and exhibit a change in respective areas of contact with one or both of the positive or negative electrodes in response to a force or strain applied on the flexible solid-state electrolytic element, and
wherein the areas of contact between the flexible solid-state electrolytic element and the positive and negative electrodes respectively define a first and second capacitive double layer.

2. The article of claim 1, wherein the flexible solid-state electrolytic element comprises a cellulosic material coated with a cured ionic polymeric matrix or a cellulosic material distributed in a cured ionic polymeric matrix.

3. The article of claim 2, wherein the cured ionic polymeric matrix comprises nanoparticles.

4. The article of claim 2, wherein the cellulosic material comprises one or more of woven cellulosic fibers, nonwoven cellulosic fibers, paper, or cloth.

5. The article of claim 2, wherein the cured ionic polymeric matrix comprises a polymer formed by photocuring a photocurable composition comprising an ionic liquid, a prepolymer composition, and a photoinitiator.

6. The article of claim 5, wherein the ionic liquid comprises 1-ethyl-3-methylimidazolium tricyanomethanide (EMIM-TCM).

7. The article of claim 5, wherein the prepolymer composition comprises polyethylene diacrylate (PEGDA) monomers.

8. The article of any one of claim 5, wherein the photocurable composition comprises about 50 wt. % of the ionic liquid, about 40 wt. % of the prepolymer composition, and about 10 wt. % of the photoinitiator.

9. The article of claim 1,
wherein the flexible solid-state electrolytic element comprises a first portion adjacent to or in contact with the positive electrode and a second portion adjacent to or in contact with the negative electrode, and
wherein the first and second portions conform to curvatures that define the respective areas of contact with the positive and negative electrodes.

10. The article of claim 1, wherein the flexible solid-state electrolytic element comprises a planar sheet, an arched sheet, a corrugated sheet, a ring, or a cylinder.

11. The article of any one of claim 1, further comprising a support layer, wherein the flexible solid-state electrolytic element is between the support layer and the positive and negative electrodes.

12. The article of claim 1, further comprising a base layer, wherein the positive and negative electrodes are between the base layer and the flexible solid-state electrolytic element.

13. A force sensor comprising the article of claim 1.

14. A strain sensor comprising the article of claim 1.

15. A method for forming a flexible solid-state electrolytic element, the method comprising:
wetting a cellulosic material with a photocurable composition comprising an ionic liquid, a prepolymer composition, and a photoinitiator; and
photocuring the photocurable composition for a predetermined curing period by exposing the wetted cellulosic material to a predetermined curing wavelength of light.

16. The method of claim 15, wherein the ionic liquid comprises 1-ethyl-3-methylimidazolium tricyanomethanide (EMIM-TCM).

17. The method of claim 15, wherein the prepolymer composition comprises polyethylene diacrylate (PEGDA) monomers.

18. The method of claim 15, wherein the photocurable composition comprises about 50 wt. % of the ionic liquid, about 40 wt. % of the prepolymer composition, and about 10 wt. % of the photoinitiator.

19. The method of claim 15, further comprising, before the photocuring, forming the wetted cellulosic material in a predetermined geometry.

20. A method of manufacturing a sensor comprising:
forming a flexible solid-state electrolytic element according to claim 15; and
arranging the flexible solid-state electrolytic element between a positive electrode and a negative electrode such that the flexible solid-state electrolytic element adjacent to or in contact with both the positive electrode and the negative electrode, wherein the flexible solid-state electrolytic element is configured to deform and exhibit a change in respective areas of contact with the positive and negative electrodes in response to a force applied on the flexible solid-state electrolytic element.
